(19) United States
(12) Patent Application Publication
(10) Pub. No.: US 2022/0335828 A1
(43) Pub. Date: Oct. 20, 2022

(54) POSITION INFORMATION ACQUISITION SYSTEM AND POSITION INFORMATION ACQUISITION METHOD

(71) Applicant: TOYOTA JIDOSHA KABUSHIKI KAISHA, Toyota-shi Aichi-ken (JP)

(72) Inventors: Hideyuki Matsui, Sunto-gun Shizuoka-ken (JP); Hiromitsu Urano, Numazu-shi Shizuoka-ken (JP)

(21) Appl. No.: 17/696,233

(22) Filed: Mar. 16, 2022

(30) Foreign Application Priority Data
Apr. 14, 2021 (JP) 2021-068364

(51) Int. Cl. G08G 1/137

(52) U.S. Cl. CPC G08G 1/137

(57) ABSTRACT

A position information acquisition system according to the present disclosure includes: a server that receives request data from a terminal and transmits information corresponding to a content of the received request data to the terminal; and a plurality of markers each representing a code that allows acquisition of the request data by a predetermined identification method. A vehicle identifies an image marker, acquires the request data, and transmits the request data to the server. When a transmission source of the received request data is the vehicle, the server transmits position information at a specific location where the image marker is installed to the vehicle regardless of the content of the request data.

### CROSS-REFERENCE TO RELATED APPLICATION

This application claims priority to Japanese Patent Application No. 2021-068364 filed on Apr. 14, 2021, incorporated herein by reference in its entirety.

### BACKGROUND

### 1. Technical Field

The present disclosure relates to a position information acquisition system and a position information acquisition method for acquiring position information that allows a vehicle to specify a position and a posture of the vehicle itself on a map.

### 2. Description of Related Art

Japanese Unexamined Patent Application Publication No. 2011-013075 (JP 2011-013075 A) discloses a vehicle position estimation system capable of inexpensively realizing reliable position detection even in an environment where global positioning system (GPS) signals cannot be received. This vehicle position estimation system is composed of an image marker in which position information is embedded and a vehicle that receives a GPS signal to specify the position of the vehicle itself. The vehicle has image recognition means for acquiring the position information embedded in the image marker from the image taken by the camera, and when the GPS signal cannot be received, the vehicle estimates the position of the vehicle itself based on the position information acquired by the image recognition means.

### SUMMARY

In an autonomous driving vehicle that autonomously travels, it is required to accurately perform self-position estimation for estimating the position and the posture of the vehicle itself on the map. In the self-position estimation, in general, a method is partially performed in which the position and the posture of the vehicle itself on the map are estimated from the movement amount based on the information of the position and the posture of the vehicle itself on the map at the point where the estimation is started. Here, the accuracy of the information of the position and the posture of the vehicle itself on the map at the point where the estimation is started affects the accuracy of the self-position estimation. Therefore, it is necessary to accurately specify the position and the posture of the vehicle itself on the map at the point where the estimation is started.

The applicants of the present disclosure have considered to acquire information (hereinafter, also referred to as “position information”) that can specify the position and the posture on the map by an image marker, assuming that the vehicle departing from a specific location such as a public bus stop or a taxi stand travels autonomously. That is, the image marker is installed at a specific location such as a stop/stand, and the vehicle acquires the position information at the specific location. The position and the posture of the vehicle itself on the map are specified from the acquired position information, and the self-position estimation and autonomous traveling are started. At this time, from the viewpoint of convenience and cost, the image marker is considered to represent a generally popular code rather than a special code. Therefore, it is assumed that a general user acquires information from the image marker out of curiosity.

Here, as disclosed in JP 2011-013075 A, if the information that can be acquired from the image marker is the position information, the user will acquire information that is meaningless to himself/herself, which may cause irritation to the user.

The present disclosure has been made in view of the above issue, and the object of the present disclosure is to provide a position information acquisition system and a position information acquisition method that allow a vehicle to acquire position information from an image marker without causing a general user to acquire meaningless information.

A position information acquisition system according to the first disclosure is a system that acquires position information that allows a vehicle to specify a position and a posture of the vehicle itself on a map. The position information acquisition system includes: a server that receives request data from a terminal and transmits information corresponding to a content of the received request data to the terminal; a plurality of image markers each representing a code that allows acquisition of the request data by a predetermined identification method; a camera that is provided in the vehicle and that captures an environment around the vehicle; an information processing device that is provided in the vehicle and that executes a process of identifying the image marker imaged by the camera based on the predetermined identification method and acquiring the request data; and a communication device that is provided in the vehicle, that transmits the request data to the server, and that receives information from the server. Here, each of the image markers is installed at a specific location. When the server receives the request data from the vehicle, the server transmits the position information at the specific location where the image marker is installed to the vehicle regardless of the content of the request data.

The position information acquisition system according to the second disclosure further includes the following features with respect to the position information acquisition system according to the first disclosure. The server is a web server and the request data is a URL.

A position information acquisition system according to the third disclosure is a system that acquires position information that allows a vehicle to specify a position and a posture of the vehicle itself on a map. The position information acquisition system includes: a plurality of image markers each representing a code that allows acquisition of data by a predetermined identification method; a camera that is provided in the vehicle and that captures an environment around the vehicle; and an information processing device provided in the vehicle. Here, each of the image markers is installed at a specific location. The information processing device stores a correspondence table for associating the position information at the specific location with the data acquired from the image marker. The information processing device executes a process of acquiring information from the camera, an identification process of identifying the image marker imaged by the camera based on the predetermined identification method and acquiring the data from the image marker, and a conversion process of acquiring the position information associated with the data acquired by the identification process based on the correspondence table.

The position information acquisition system according to the fourth disclosure further includes the following features with respect to the position information acquisition system according to the third disclosure. The data acquired from the image marker is a URL.

The position information acquisition system according to the fifth disclosure further includes the following features with respect to the position information acquisition system according to the third disclosure or the fourth disclosure. The correspondence table associates the position information at the specific location with a combination of the data acquired from the image marker and a category of the code represented by the image marker. In the identification process, the information processing device further acquires information on the category of the code represented by the image marker imaged by the camera. In the conversion process, the information processing device acquires the position information associated with the combination of the data acquired by the identification process and the category of the code based on the correspondence table.

A position information acquisition method according to the sixth disclosure is a method for acquiring position information that allows a vehicle to specify a position and a posture of the vehicle itself on a map. In the position information acquisition method, in the vehicle, a processor that executes at least one program executes a process of acquiring information from a camera that images an environment around the vehicle, a process of identifying an image marker imaged by the camera based on a predetermined identification method and acquiring request data, and a process of transmitting the request data to a server and receiving information from the server. In the server, a processor that executes at least one program executes a process of determining whether a transmission source of the received request data is the vehicle, and a process of transmitting, when the transmission source of the received request data is the vehicle, the position information at a specific location where the image marker is installed to the vehicle regardless of a content of the request data. Here, a server is a device that receives the request data from a terminal and transmits information corresponding to the content of the request data to the terminal. An image marker is a marker that is installed at the specific location and that represents a code that allows acquisition of the request data by the predetermined identification method.

A position information acquisition method according to the seventh disclosure is a method for acquiring position information that allows a vehicle to specify a position and a posture of the vehicle itself on a map. In the position information acquisition method, a processor that executes at least one program executes a process of acquiring information from a camera that images an environment around the vehicle, a process of identifying an image marker imaged by the camera based on a predetermined identification method and acquiring data, and a process of acquiring the position information associated with the data acquired by the identification process based on a correspondence table that associates the position information at a specific location with the data acquired from the image marker.

With the position information acquisition system and the position information acquisition method according to the present disclosure, the vehicle can acquire the position information at the specific location using the image marker installed at the specific location. In addition, the code represented by the image marker can be configured to indicate appropriate request data or appropriate data. Particularly, the request data or the data can be configured so that the user can acquire meaningful information. As a result, it is possible to prevent the user from acquiring meaningless information from the image marker.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an outline of a position information acquisition system according to a first embodiment;

FIG. 2 is a conceptual diagram showing an example in which the position information acquisition system is applied to a case where a vehicle autonomously travels in a plurality of specific locations;

FIG. 3 is a block diagram illustrating an example of a vehicle configuration according to the first embodiment;

FIG. 4 is a block diagram illustrating processes executed by an information processing device according to the first embodiment;

FIG. 5A is a conceptual diagram illustrating an example of position information acquired from a server and a position specification process executed by a self-position estimation processing unit;

FIG. 5B is a conceptual diagram illustrating the example of the position information acquired from the server and the position specification process executed by the self-position estimation processing unit;

FIG. 6 is a flowchart showing a process in a vehicle in a position information acquisition method executed by the position information acquisition system according to the first embodiment;

FIG. 7 is a flowchart showing a process in a server in the position information acquisition method executed by the position information acquisition system according to the first embodiment;

FIG. 8 is a conceptual diagram illustrating an outline of a process executed by an information processing device according to a modification of the first embodiment;

FIG. 9 is a block diagram illustrating processes executed by the information processing device according to the modification of the first embodiment;

FIG. 10 is a conceptual diagram illustrating an outline of a position information acquisition system according to a second embodiment;

FIG. 11A is a conceptual diagram showing an example of a correspondence table according to the second embodiment;

FIG. 11B is a conceptual diagram showing the example of the correspondence table according to the second embodiment;

FIG. 12 is a block diagram illustrating processes executed by an information processing device according to the second embodiment;

FIG. 13 is a flowchart showing a position information acquisition method executed by the position information acquisition system according to the second embodiment;

FIG. 14 is a flowchart showing a process executed by a conversion processing unit in the position information acquisition system according to a first modification of the second embodiment;

FIG. 15 is a conceptual diagram showing an example of a correspondence table according to the first modification of the second embodiment; and

FIG. 16 is a conceptual diagram showing an example of a correspondence table according to a second modification of the second embodiment.

### DETAILED DESCRIPTION OF EMBODIMENTS

Hereinafter, embodiments of the present disclosure will be described with reference to the drawings. However, when the number, quantity, amount, range, etc. of each element are referred to in the embodiments shown below, the idea of the present disclosure is not limited to the numbers mentioned herein except when explicitly stated or when clearly specified by the number in principle. In addition, the configurations and the like described in the embodiments shown below are not necessary to the idea of the present disclosure, except when explicitly stated or when clearly specified in principle. In each figure, the same or corresponding parts are designated by the same reference signs, and duplicated description thereof will be appropriately simplified or omitted.

### 1. First Embodiment

1-1. Outline

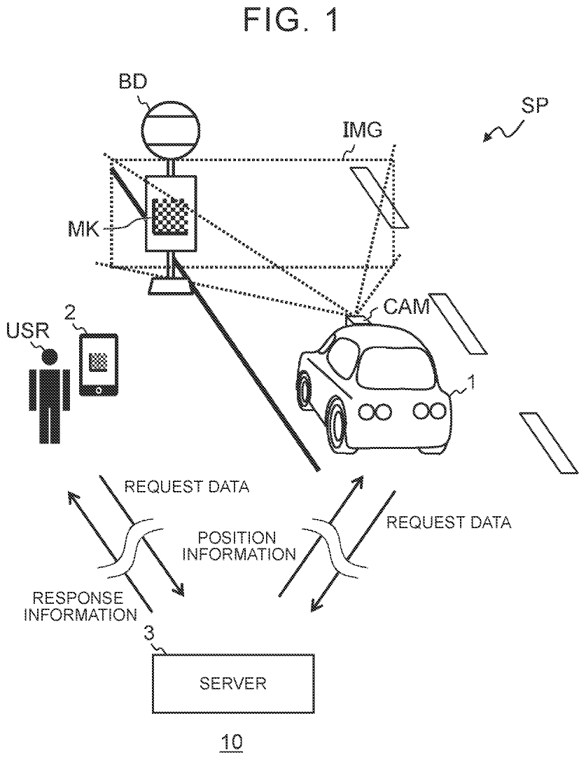

A position information acquisition system 10 according to a first embodiment is applied to a case where a vehicle departing from a specific location such as a public bus stop or a taxi stand autonomously travels. FIG. 1 is a conceptual diagram illustrating an outline of the position information acquisition system 10 according to the first embodiment. A vehicle 1 shown in FIG. 1 is an autonomous driving vehicle that departs from a specific location SP and autonomously travels. The vehicle 1 is typically a public bus or taxi that is used by a general user USR and autonomously travels. FIG. 1 shows a stop/stand where the vehicle 1 stops and the user USR gets on and off the vehicle 1 as the specific location SP.

The position information acquisition system 10 includes an image marker MK and a server 3. The image marker MK represents a code that allows acquisition of data by a predetermined identification method. For example, the image marker MK is a stack-type or matrix-type two-dimensional code. However, the image marker MK may be other codes. Typically, the code represented by the image marker MK is a generally popular code, and is a code that allows acquisition of data by a user terminal 2 (for example, a smartphone) possessed by the user USR.

The image marker MK is installed at the specific location SP. For example, as shown in FIG. 1, the image marker MK is installed on a signboard BD at the specific location SP.

The server 3 is a device that is configured (or that may be virtually configured) on a communication network, receives request data in a predetermined format from a terminal connected to the communication network, and transmits the information corresponding to the content of the request data (response information) to the terminal. The server 3 is typically a web server configured on the Internet. The request data is typically a uniform resource locator (URL).

In the position information acquisition system 10, the code represented by the image marker MK indicates the request data for the server 3. That is, by acquiring the request data from the image marker MK and transmitting the acquired request data from the terminal to the server 3, the terminal can receive the information corresponding to the content of the request data (response information) from the server 3.

Thus, the user USR can acquire information from the image marker MK via the user terminal 2 as follows. Here, the case where the server 3 is a web server and the request data is a URL will be described as an example. The user USR acquires the URL from the image marker MK using a function of the user terminal 2 (for example, an application installed on the user terminal 2). The URL specifies the data stored in the server 3. Typically, a hypertext markup language (HTML) file, an image file, or the like indicating a predetermined web page is specified.

Next, the user terminal 2 connected to the Internet requests data from the server 3 according to the URL, and the server 3 transmits data corresponding to the content of the URL to the user terminal 2. Then, the user terminal 2 receives the data from the server 3 and notifies the user USR of information on the data. Typically, the user terminal 2 notifies the user USR by displaying the information according to an HTML file or the like received from the server 3 via an appropriate web browser.

In this way, the user USR can acquire information from the image marker MK via the user terminal 2. Here, by setting the data specified by the URL to appropriate data such as an HTML file that displays a timetable or service information, the user USR can acquire meaningful information from the image marker MK.

The vehicle 1 according to the first embodiment includes a camera CAM that captures an image of the surrounding environment, and the vehicle 1 acquires image data of an imaging area IMG. The vehicle 1 includes an information processing device (not shown in FIG. 1), and the vehicle 1 subsequently acquires the request data from the image marker MK included in the image data based on a predetermined identification method. The vehicle 1 includes a communication device (not shown in FIG. 1), and the vehicle 1 then communicates with the server 3, transmits the request data to the server 3, and receives the information from the server 3.

Here, when the server 3 according to the first embodiment receives the request data from the vehicle 1, the server 3 transmits to the vehicle 1 information (position information) that allows the vehicle 1 to specify the position and the posture of the vehicle itself on the map at the specific location SP, regardless of the content of the request data. That is, the vehicle 1 can acquire the position information at the specific location SP from the server 3 by transmitting the request data acquired from the image marker MK to the server 3 via the communication device.

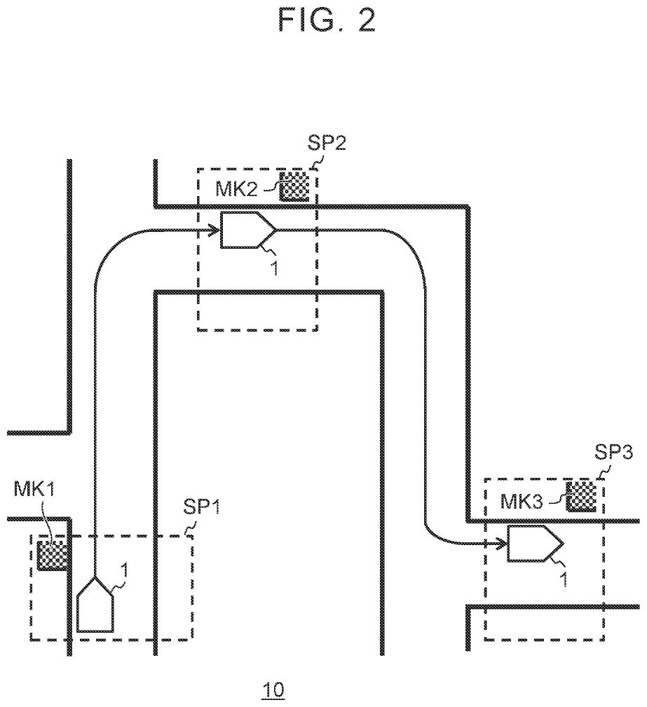

The position information acquisition system 10 may be configured such that a plurality of specific locations SP exist and the image marker MK is installed at each specific location SP. FIG. 2 is a conceptual diagram showing an example in which the position information acquisition system 10 is applied to a case where the vehicle 1 autonomously travels in a plurality of specific locations SP1, SP2, and SP3.

FIG. 2 shows a case where the vehicle 1 is scheduled to travel in the specific locations SP1, SP2, and SP3 in the order of SP1, SP2, and SP3 by autonomous traveling. For example, the vehicle 1 is a public bus, and the specific locations SP1, SP2, and SP3 are public bus stops.

The image marker MK is installed at each of the specific locations SP1, SP2, and SP3. As shown in FIG. 2, each image marker MK installed at the specific locations SP1, SP2, and SP3 is given a number in the reference sign to distinguish one from another.

The vehicle 1 first acquires the request data from the image marker MK1 at the specific location SP1 and transmits the request data to acquire the position information at the specific location SP1 from the server 3. Then, the vehicle 1 specifies the position and the posture of the vehicle itself on the map from the position information, starts the self-position estimation and autonomous traveling, and travels toward the specific location SP2. Next, the vehicle 1 acquires the request data from the image marker MK2 at the specific location SP2 and transmits the request data to acquire the position information at the specific location SP2 from the server 3. Then, the vehicle 1 specifies the position and the posture of the vehicle itself on the map from the position information, starts the self-position estimation and autonomous traveling, and travels toward the specific location SP3.

After that, the vehicle 1 repeats the same process at the specific location SP3, specifies the position and the posture of the vehicle itself on the map, and starts the self-position estimation and autonomous traveling. The same applies to the case where the position information acquisition system 10 includes an image marker MK installed at each of a larger number of the specific locations SP.

In this way, the vehicle 1 acquires the position information from the image marker MK at each of the specific locations SP, specifies the position and the posture of the vehicle itself on the map, and starts the self-position estimation and autonomous traveling. Therefore, it is possible to autonomously travel to the next specific location SP based on the updated and more accurate self-position estimation.

Here, the codes represented by the image markers MK1, MK2, and MK3 typically indicate different request data. That is, when the server 3 receives the request data from the vehicle 1, the server 3 determines that the request data is acquired from the image marker MK installed at any of the specific locations SP1, SP2, and SP3, and transmits the position information at the corresponding specific location SP to the vehicle 1. As a result, the server 3 can select and transmit the position information at each of the specific locations SP1, SP2, and SP3.

However, the codes represented by the image markers MK1, MK2, and MK3 may indicate the same request data, and the server 3 may select and transmit the position information based on the information related to the communication of the request data. For example, when the communication device provided in the vehicle 1 transmits the request data via a base station, the server 3 may determine that the request data is acquired from the image marker MK installed at any of the specific locations SP1, SP2, and SP3, and may transmit the position information at the corresponding specific location SP to the vehicle 1.

As described above, when the request data acquired from the image markers MK1, MK2, and MK3 is transmitted to the server 3 from a terminal other than the vehicle 1, the server 3 transmits information corresponding to the content of the request data to the terminal.

1-2. Vehicle Configuration Example

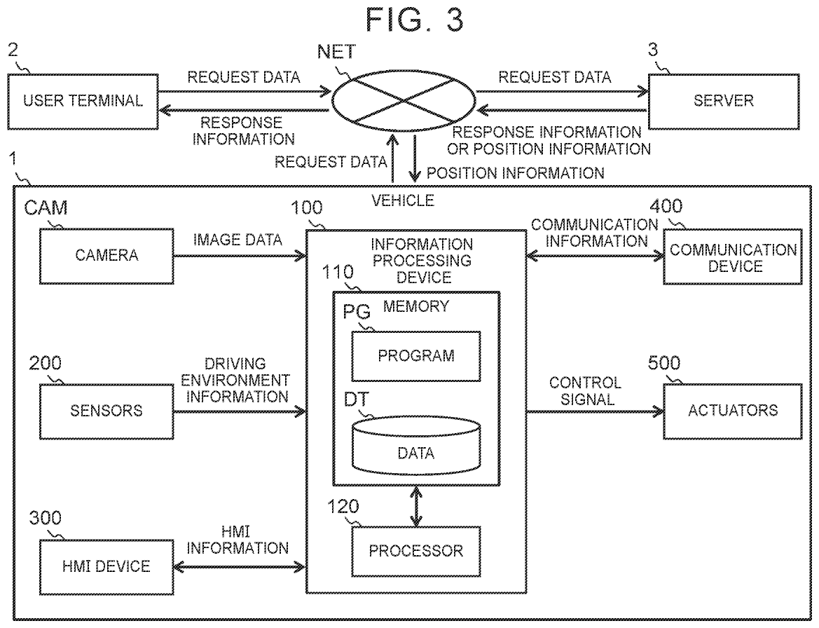

FIG. 3 is a block diagram illustrating an example of a configuration of the vehicle 1 according to the first embodiment. The vehicle 1 includes the camera CAM, an information processing device 100, sensors 200, a human machine interface (HMI) device 300, a communication device 400, and actuators 500. The information processing device 100 is configured to be able to transmit information to each other with the camera CAM, the sensors 200, the HMI device 300, the communication device 400, and the actuators 500. Typically, the above components are electrically connected by a wire harness.

The camera CAM captures an image of the environment around the vehicle 1 and outputs image data. Here, the camera CAM may be limited to a camera that captures an image of an environment in a specific range around the vehicle 1. For example, the camera CAM may be a camera that captures an image of the environment in front of the vehicle 1. The image data output by the camera CAM is transmitted to the information processing device 100.

The sensors 200 are sensors that detect and output information indicating the driving environment of the vehicle 1 (driving environment information). The driving environment information output by the sensors 200 is transmitted to the information processing device 100. The sensors 200 typically include sensors that detect information on the environment of the vehicle 1 such as the traveling state of the vehicle 1 (vehicle speed, acceleration, yaw rate, etc.) and sensors that detect information on the environment around the vehicle 1 (preceding vehicle, lanes, obstacles, etc.).

Examples of the sensors that detect the information on the environment of the vehicle 1 include a wheel speed sensor for detecting the vehicle speed of the vehicle 1, an acceleration sensor for detecting the acceleration of the vehicle 1, an angular velocity sensor for detecting the yaw rate of the vehicle 1, and the like. Examples of the sensors that detect the environment around the vehicle 1 include a millimeter wave radar, a sensor camera, light detection and ranging (LiDAR), and the like. Here, the camera CAM may be a sensor that detects the environment around the vehicle 1. For example, a sensor camera may function as the camera CAM.

The HMI device 300 is a device having an HMI function. The HMI device 300 gives various types of HMI information to the information processing device 100 through operation by an operator or the like of the vehicle 1, and also notifies the operator or the like of the HMI information related to the processes executed by the information processing device 100. The HMI device 300 is, for example, a switch, a touch panel display, an automobile meter, or a combination thereof.

The information processing device 100 executes various processes such as control of the vehicle 1 based on the acquired information, and outputs the execution result. The execution result is transmitted to the actuators 500 as a control signal, for example. Alternatively, the execution result is transmitted to the communication device 400 as communication information. The information processing device 100 may be a device outside the vehicle 1. In this case, the information processing device 100 acquires information and outputs the execution result by communicating with the vehicle 1.

The information processing device 100 is a computer including a memory 110 and a processor 120. Typically, the information processing device 100 is an electronic control unit (ECU). The memory 110 stores a program PG that can be executed by a processor, and data DT that includes information acquired by the information processing device 100 and various types of information related to the program PG. Here, the memory 110 may store time-series data of the acquired information for a certain period of time as the data DT. The processor 120 reads the program PG from the memory 110, and executes a process according to the program PG based on the information of the data DT read from the memory 110.

Processes executed by the information processing device 100, more specifically, processes executed by the processor 120 according to the program PG include a process of identifying the image marker MK and acquiring the request data, a process related to the self-position estimation, and a process related to autonomous traveling. Details of these processes will be described later. Here, the request data acquired from the image marker MK by the processes executed by the information processing device 100 is transmitted to the communication device 400 as the communication information.

The information processing device 100 may be a system composed of a plurality of computers. In this case, each of the computers is configured to be able to transmit information to each other to the extent that information necessary for executing the process can be acquired. Further, the program PG may be a combination of a plurality of programs.

The communication device 400 is a device that transmits and receives various types of information (communication information) by communicating with a device outside the vehicle 1. The communication device 400 is configured to be able to connect to at least a communication network NET in which the server 3 is configured and transmit/receive information to/from the server 3. For example, the server 3 is configured on the Internet, and the communication device 400 is a device capable of connecting to the Internet and transmitting/receiving information. In this case, typically, the communication device 400 is a terminal that connects to the Internet via a base station and transmits/receives information by wireless communication.

The communication information received by the communication device 400 is transmitted to the information processing device 100. The communication information transmitted to the information processing device 100 includes at least the position information received from the server 3. Further, the request data acquired by the communication device 400 from the information processing device 100 is transmitted from the communication device 400 to the server 3.

The communication device 400 may include other devices. For example, the communication device 400 may include a device for performing vehicle-to-vehicle communication and road-to-vehicle communication, a global positioning system (GPS) receiver, and the like. In this case, the communication device 400 indicates a type of these devices.

The actuators 500 are types of actuators that operate according to a control signal acquired from the information processing device 100. The actuators included in the actuators 500 include, for example, an actuator for driving an engine (internal combustion engine, an electric motor, or a hybrid thereof, etc.), an actuator for driving a brake mechanism provided in the vehicle 1, and an actuator for driving a steering mechanism of the vehicle 1. By operating the various actuators included in the actuators 500 according to the control signal, various controls of the vehicle 1 are realized by the information processing device 100.

As described above, the vehicle 1 transmits the request data to the server 3 and receives the position information from the server 3 via the communication device 400. When the server 3 receives the request data from the vehicle 1 via the communication device 400, the server 3 transmits the position information to the vehicle 1, whereas when the server 3 receives the request data from a terminal other than the vehicle 1 connected to the communication network NET (for example, the user terminal 2), the server 3 transmits the information corresponding to the content of the request data (response information). That is, the server 3 operates so that the information to be transmitted differs depending on whether the transmission source of the received request data is the vehicle 1.

1-3. Processes Executed by Information Processing Device

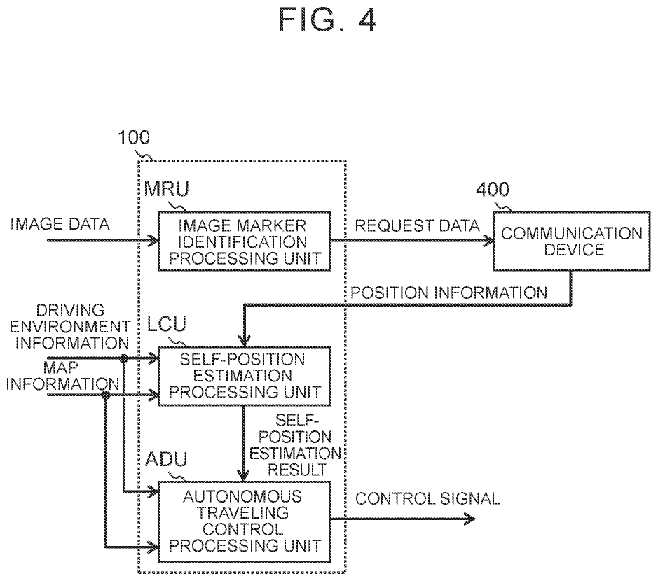

FIG. 4 is a block diagram illustrating the processes executed by the information processing device 100. As shown in FIG. 4, the processes executed by the information processing device 100 are configured by an image marker identification processing unit MRU, a self-position estimation processing unit LCU, and an autonomous traveling control processing unit ADU. These may be realized as a part of the program PG, or may be realized by a separate computer constituting the information processing device 100.

The image marker identification processing unit MRU executes a process of identifying the image marker MK imaged by the camera CAM from the image data output by the camera CAM and acquiring the request data. The image marker identification processing unit MRU executes the process based on a predetermined identification method related to the image marker MK. For example, when the image marker MK represents a matrix-type two-dimensional code, the image marker identification processing unit MRU executes image analysis of the image data and recognizes a part representing the image marker MK that is included in the image data. Then, by the image processing for the image marker MK, the image marker identification processing unit MRU identifies the cell pattern of the two-dimensional code and acquires the request data.

The information processing device 100 outputs the request data acquired by the process executed by the image marker identification processing unit MRU and transmits the request data to the communication device 400. The communication device 400 transmits the acquired request data to the server 3 and receives the position information from the server 3. Then, the communication device 400 outputs the position information received from the server 3 and transmits the position information to the information processing device 100.

The self-position estimation processing unit LCU executes a process related to the self-position estimation for estimating the position and the posture of the vehicle 1 on the map. Typically, based on the driving environment information and the map information, the position and the posture of the vehicle 1 on the map are estimated moment by moment from the movement amount of the vehicle 1 from the point where the estimation is started and the position of the vehicle 1 relative to the surrounding environment. The result of the self-position estimation (self-position estimation result) performed by the self-position estimation processing unit LCU is transmitted to the autonomous traveling control processing unit ADU.

Here, the degree of freedom of the position and the posture of the vehicle 1 on the map estimated by the self-position estimation processing unit LCU is not limited. For example, the position of the vehicle 1 on the map may be given by two-dimensional coordinate values (X, Y) and the posture of the vehicle 1 may be given by the yaw angle θ, or the position and the posture of the vehicle 1 on the map may be given by three degrees of freedom.

The map information may be information stored in advance in the memory 110 as the data DT, or may be information acquired from the outside via the communication device 400. Alternatively, the map information may be the information of the environment map generated by a process executed by the information processing device 100.

The process executed by the self-position estimation processing unit LCU includes a process of specifying the position and the posture of the vehicle itself on the map from the position information acquired by the information processing device 100 (hereinafter, also referred to as “position specification process”). Typically, the self-position estimation processing unit LCU starts the estimation based on the information of the position and the posture of the vehicle itself on the map specified in the position specification process. An example of the position information and the position specification process will be described later.

The autonomous traveling control processing unit ADU executes a process related to autonomous traveling of the vehicle 1 and generates a control signal for performing autonomous traveling. Typically, a travel plan to a destination is set, and a travel route is generated based on the travel plan, the driving environment information, the map information, and the self-position estimation result. Then, control signals related to acceleration, braking, and steering are generated so that the vehicle 1 travels along the travel route.

The image marker identification processing unit MRU may be configured to execute the process when a predetermined operation of the HMI device 300 is performed. The self-position estimation processing unit LCU and the autonomous traveling control processing unit ADU may be configured to start the self-position estimation and autonomous traveling when the information processing device 100 acquires the position information. For example, the image marker identification processing unit MRU may be configured to execute the process when a predetermined switch provided in the vehicle 1 is pressed, with the HMI information regarded as input. In this case, when the predetermined switch is pressed, the vehicle 1 starts the self-position estimation and autonomous traveling.

1-4. Position Information and Position Specification Process

The position information at the specific location SP acquired by the vehicle 1 from the server 3 is information that allows the vehicle 1 to specify the position and the posture of the vehicle itself on the map at the specific location SP. Further, the self-position estimation processing unit LCU shown in FIG. 4 executes the position specification process and specifies the position and the posture of the vehicle itself on the map from the position information. The following describes an example of the position information acquired by the vehicle 1 from the server 3 and the position specification process executed by the self-position estimation processing unit LCU.

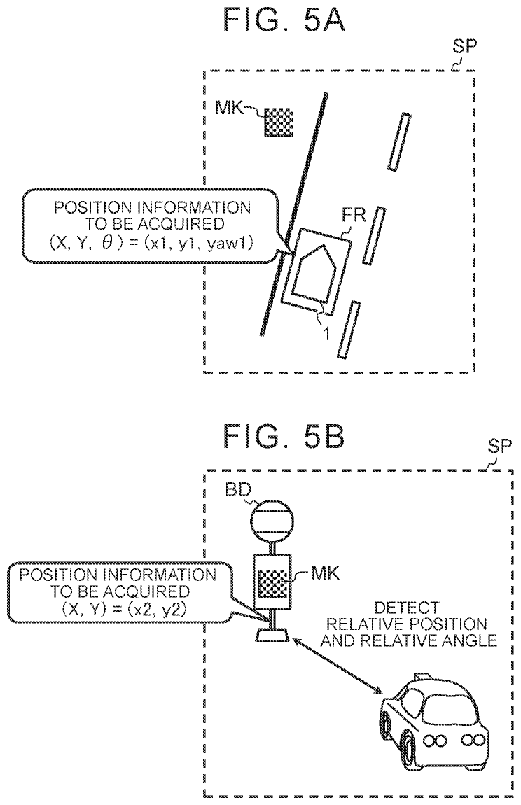

FIGS. 5A and 5B are conceptual diagrams illustrating an example of the position information acquired by the vehicle 1 from the server 3 and the position specification process executed by the self-position estimation processing unit LCU. FIGS. 5A and 5B show two examples of the position information and the position specification process.

In the example shown in FIG. 5A, a stop frame FR for stopping the vehicle 1 at a specific location SP is provided. The stop frame FR is, for example, a stop position of a stop/stand. The position information acquired by the vehicle 1 from the server 3 is the position and the posture of the vehicle 1 on the map when the vehicle 1 is stopped along the stop frame FR. For example, as shown in FIG. 5A, the two-dimensional coordinate values and the yaw angle (X, Y, θ) of the vehicle 1 when the vehicle 1 is stopped along the stop frame FR is regarded as the position information to be acquired.

In the position specification process, the self-position estimation processing unit LCU may regard the position information to be acquired as the position and the posture of the vehicle itself on the map to be specified. Alternatively, the self-position estimation processing unit LCU may correct the position information from the information on the relative position between the vehicle 1 and the stop frame FR, and regard the corrected position information as the position and the posture of the vehicle itself on the map to be specified. That is, the vehicle 1 can specify the position and the posture of the vehicle itself on the map by acquiring the position information with the vehicle stopped along the stop frame FR.

In the example shown in FIG. 5B, the position information acquired by the vehicle 1 from the server 3 is the position on the map where the image marker MK is installed. For example, as shown in FIG. 5B, when the image marker MK is installed on the signboard BD, the two-dimensional coordinates (X, Y) of the signboard BD are regarded as the position information to be acquired. Further, the sensors 200 detect the relative position and the relative angle of the vehicle 1 with respect to the position where the image marker MK is installed.

Then, in the position specification process, the self-position estimation processing unit LCU specifies the position and the posture of the vehicle itself on the map from the position information to be acquired and the information on the relative position and the relative angle to be detected. That is, the vehicle 1 can specify the position and the posture of the vehicle itself on the map by detecting the image marker MK at the specific location SP and acquiring the position information.

1-5. Position Information Acquisition Method

Hereinafter, the position information acquisition method executed by the position information acquisition system 10 according to the first embodiment will be described.

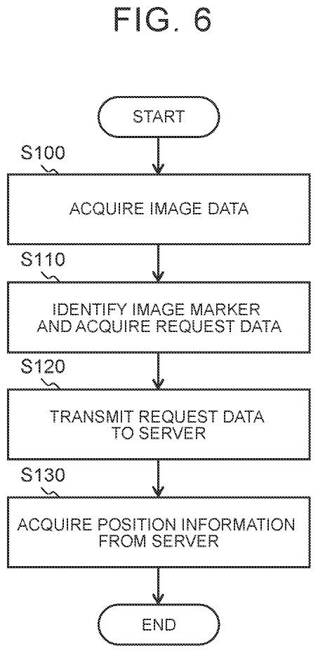

FIG. 6 is a flowchart showing a process in the vehicle 1 in the position information acquisition method executed by the position information acquisition system 10 according to the first embodiment. The process shown in FIG. 6 is executed when the vehicle 1 is stopped at the specific location SP and the camera CAM is capturing an image of the image marker MK. The determination of the start of the process may be repeated at predetermined intervals, or may be made on condition that the operator of the vehicle 1 or the like performs a predetermined operation of the HMI device 300.

In step S100, the camera CAM captures an image of the environment around the vehicle 1, and the information processing device 100 acquires the image data from the camera CAM. After step S100, the process proceeds to step S110.

In step S110, the image marker identification processing unit MRU identifies the image marker MK from the image data and acquires the request data. After step S110, the process proceeds to step S120.

In step S120, the communication device 400 transmits the request data to the server 3. After step S120, the process proceeds to step S130.

In step S130, the communication device 400 acquires the position information from the server 3. After step S130, the process ends.

After the process shown in FIG. 6 is completed, typically, the self-position estimation processing unit LCU specifies the position and the posture of the vehicle itself on the map from the acquired position information, and starts the self-position estimation. Further, the autonomous traveling control processing unit ADU starts autonomous traveling.

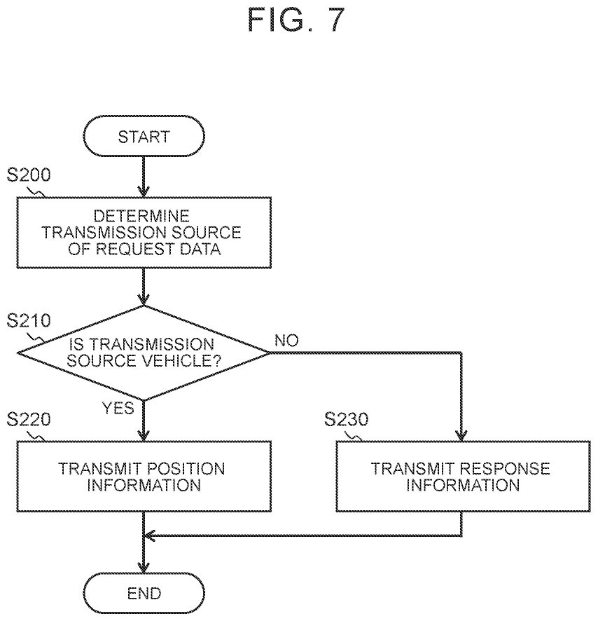

FIG. 7 is a flowchart showing a process in the server 3 in the position information acquisition method executed by the position information acquisition system 10 according to the first embodiment. The process shown in FIG. 7 starts when the server 3 acquires the request data from the terminal.

In step S200, the server 3 determines the transmission source of the acquired request data. This can be done as follows, for example, assuming that the communication network NET is the Internet.

A fixed IP address is assigned to the communication device 400, and the server 3 determines whether the transmission source of the request data is the vehicle 1 from the IP address or a host name of the transmission source. Alternatively, the communication device 400 operates by a specific operating system (OS), and the server 3 determines whether the transmission source of the request data is the vehicle 1 from the information of the OS name of the transmission source. Alternatively, assuming that the server 3 is a web server and the request data is a URL, the communication device 400 makes a request to the server 3 according to the URL by a specific browser, and the server 3 determines whether the transmission source of the request data is the vehicle 1 from the information on the browser type. However, it may be determined whether the transmission source of the request data is the vehicle 1 by other methods.

After step S200, the process proceeds to step S210.

In step S210, the server 3 determines whether the transmission source of the acquired request data is the vehicle. When the transmission source of the request data is the vehicle (step S210: Yes), the process proceeds to step S220. When the transmission source of the request data is not the vehicle (step S210: No), the process proceeds to step S230.

In step S220, the server 3 transmits the position information to the vehicle 1. After step S220, the process ends.

In step S230, the server 3 transmits information corresponding to the content of the request data (response information) to the terminal. After step S230, the process ends.

1-6. Effect

As described above, with the position information acquisition system 10 according to the first embodiment, the vehicle 1 can acquire the position information at the specific location SP using the image marker MK installed at the specific location SP. In addition, the code represented by the image marker MK can be configured to indicate appropriate request data. In particular, information meaningful to the user USR (for example, timetable and service information) can be used as the request data received from the server 3. As a result, it is possible to prevent the user USR from acquiring meaningless information from the image marker MK.

1-7. Modification

The position information acquisition system 10 according to the first embodiment may adopt a modified mode as follows. Hereinafter, matters described in the above-described contents are omitted as appropriate.

The information processing device 100 may be configured to execute a process of specifying an area for identifying the image marker MK from the image data acquired from the camera CAM.

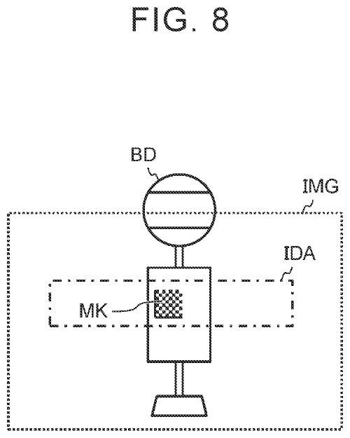

FIG. 8 is a conceptual diagram illustrating an outline of a process executed by the information processing device 100 according to a modification of the first embodiment. In FIG. 8, the information processing device 100 acquires the image data of the imaging area IMG (area surrounded by the dashed line) from the camera CAM. The information processing device 100 calculates an identification area IDA (area surrounded by the long dashed short dashed line) that specifies the area for identifying the image marker MK in the imaging area IMG from the acquired image data. Then, the information processing device 100 identifies the image marker MK on the image data of the identification area IDA.

The information processing device 100 calculates the identification area IDA based on the driving environment information. For example, the height from the ground of the position where the image marker MK is installed is calculated from the information detected by LiDAR, and the area within a predetermined range (for example, 1.5 m±50 cm) from the height is defined as the identification area IDA.

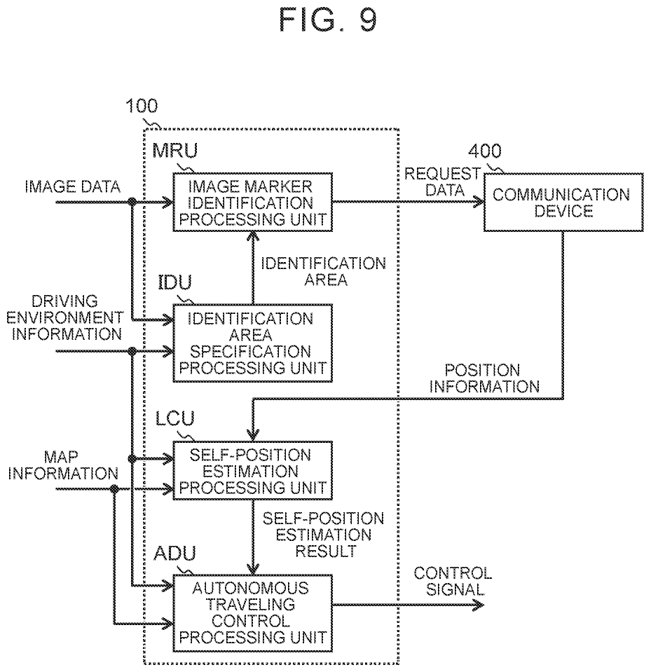

FIG. 9 is a block diagram illustrating processes executed by the information processing device 100 according to a modification of the first embodiment. As shown in FIG. 9, as compared with FIG. 3, the processes executed by the information processing device 100 according to the modification of the first embodiment are configured by further including an identification area specification processing unit IDU.

The identification area specification processing unit IDU executes a process of calculating the identification area IDA from the image data based on the driving environment information. The identification area IDA calculated by the identification area specification processing unit IDU is transmitted to the image marker identification processing unit MRU. The image marker identification processing unit MRU executes a process of identifying the image marker MK from the image data of the identification area IDA and acquiring the request data.

By calculating the identification area IDA in this way, it is possible to reduce erroneous recognition and improve the reading speed in the identification of the image marker MK performed by the information processing device 100. In addition, the size and the flexibility of the installation location of the image marker MK can be improved.

### 2. Second Embodiment

Hereinafter, a second embodiment will be described. It should be noted that the contents overlapping with the first embodiment are omitted as appropriate.

2-1. Outline

Similar to the first embodiment, a position information acquisition system according to a second embodiment is applied to a case where a vehicle 1 departing from a specific location SP such as a public bus stop or a taxi stand autonomously travels.

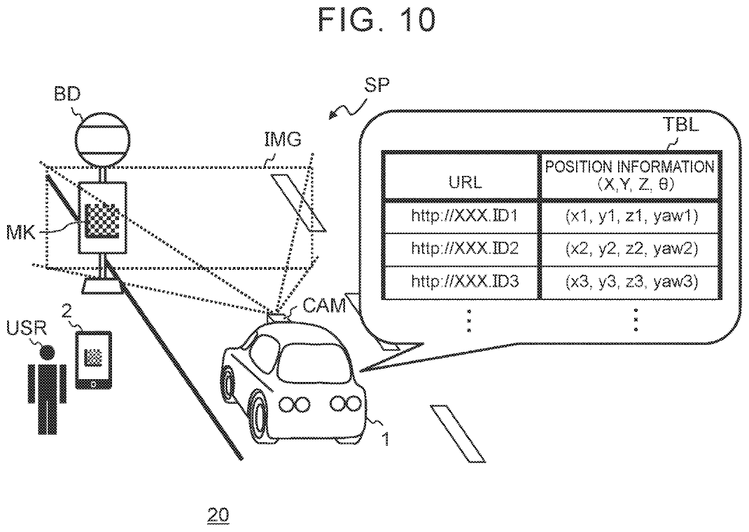

FIG. 10 is a conceptual diagram illustrating an outline of a position information acquisition system 20 according to the second embodiment.

The position information acquisition system 20 according to the second embodiment includes an image marker MK. The image marker MK represents a code that allows acquisition of data by a predetermined identification method. In the position information acquisition system 20, the data acquired from the image marker MK may be appropriately given. For example, the code represented by the image marker MK may indicate a specific URL, and the web page specified by the URL may indicate a timetable or service information. Thus, the user USR can acquire meaningful information from the image marker MK via the user terminal 2.

In the following description, it is assumed that the code represented by the image marker MK indicates a URL.

A vehicle 1 according to the second embodiment includes a camera CAM that captures an image of the surrounding environment, and the vehicle 1 acquires image data of an imaging area IMG. The vehicle 1 includes an information processing device, and the vehicle 1 subsequently acquires the URL from the image marker MK included in the image data based on a predetermined identification method.

The information processing device provided in the vehicle 1 stores a correspondence table TBL that associates the URL acquired from the image marker MK with position information at the specific location SP. Based on the correspondence table TBL, the vehicle 1 acquires the position information associated with the URL acquired from the image marker MK as the position information at the specific location SP.

The position information acquisition system 20 may be configured such that a plurality of specific locations SP exist and the image marker MK is installed at each specific location SP. For example, the position information acquisition system 20 may be applied to a case where the vehicle 1 autonomously travels in a plurality of specific locations SP as described with reference to FIG. 2. In this case, the vehicle 1 acquires the position information from the image marker MK at each specific location SP.

Here, the code represented by the image marker MK installed at each specific location SP is configured to indicate a different URL. Thereby, the vehicle 1 can select and acquire the position information at each specific location SP based on the correspondence table TBL.

However, the information that the user USR can acquire from each image marker MK via the user terminal 2 may be configured to be the same. For example, the code represented by the image marker MK may indicate a different URL due to different URL parameters, while each URL may specify the same web page.

2-2. Vehicle Configuration Example

The configuration of the vehicle 1 according to the second embodiment may be the same as the configuration shown in FIG. 3. However, the communication device 400 does not have to be able to transmit/receive information to/from the server 3. Further, the communication information related to the communication device 400 does not have to include the URL acquired from the image marker MK and the position information. Further, the server 3 may be a general server specified by the URL acquired from the image marker MK. That is, the server 3 does not have to operate depending on the transmission source of the received URL.

Here, the memory 110 stores the correspondence table TBL as the data DT. The correspondence table TBL may be information stored in advance, or may be information acquired from the outside via the communication device 400 and stored.

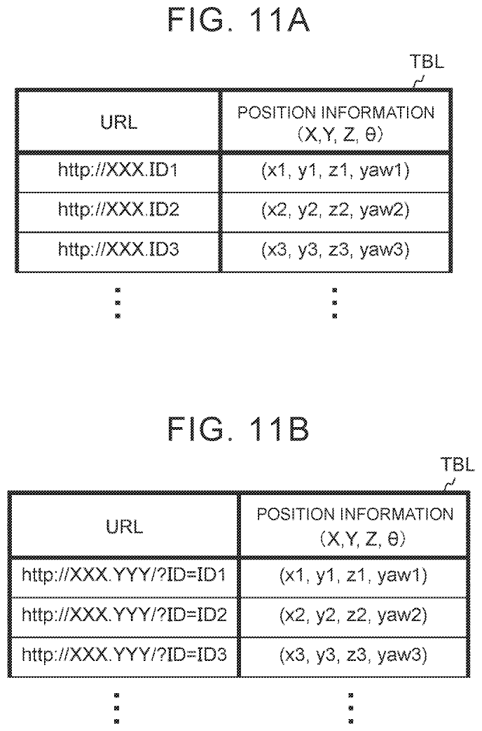

FIGS. 11A and 11B are conceptual diagrams showing an example of the correspondence table TBL according to the second embodiment. FIGS. 11A and 11B show two examples of the correspondence table TBL.

The correspondence table TBL is data that associates the position information with the URL acquired from the image marker MK. The position information corresponding to the image marker MK is information that allows the vehicle 1 to specify the position and the posture of the vehicle itself on the map at the specific location SP where the image marker MK is installed, and may be equivalent to the position information described with reference to FIGS. 5A and 5B.

FIG. 11A shows an example of the correspondence table TBL in the case where the end of the URL acquired from each image marker MK is different in the position information acquisition system 20. In the correspondence table TBL, the three-dimensional coordinates and the yaw angle (X, Y, Z, θ) of the vehicle 1 are associated with each URL.

FIG. 11B shows an example of the correspondence table TBL in the case where the URL parameters of the URL acquired from each image marker MK are different in the position information acquisition system 20. Similar to the case of FIG. 11A, in the correspondence table TBL, the three-dimensional coordinates and the yaw angle (X, Y, Z, θ) of the vehicle 1 are associated with each URL.

2-3. Processes Executed by Information Processing Device

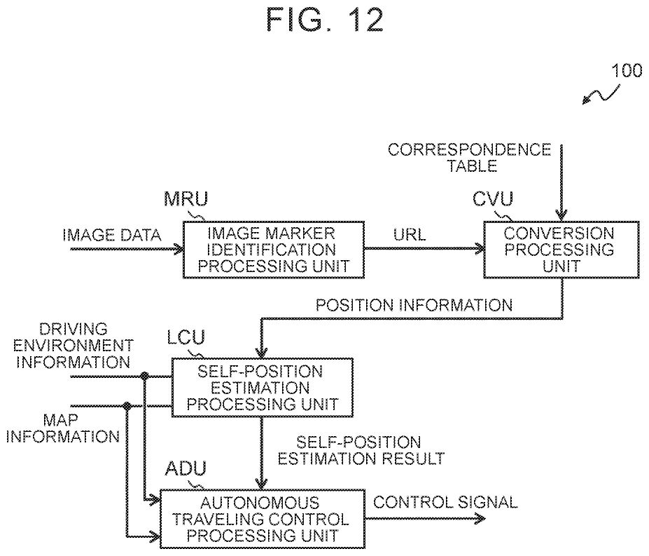

FIG. 12 is a block diagram illustrating processes executed by the information processing device 100 according to the second embodiment. As shown in FIG. 12, the processes executed by the information processing device 100 are configured by an image marker identification processing unit MRU, a conversion processing unit CVU, a self-position estimation processing unit LCU, and an autonomous traveling control processing unit ADU. These may be realized as a part of the program PG, or may be realized by a separate computer constituting the information processing device 100.

The self-position estimation processing unit LCU and the autonomous traveling control processing unit ADU are equivalent to those described with reference to FIG. 4.

The image marker identification processing unit MRU executes a process of identifying the image marker MK imaged by the camera CAM from the image data output by the camera CAM and acquiring the URL. The image marker identification processing unit MRU executes the process based on a predetermined identification method related to the image marker MK. The URL acquired by the image marker identification processing unit MRU is transmitted to the conversion processing unit CVU.

The image marker identification processing unit MRU may be configured to execute the process when a predetermined operation of the HMI device 300 is performed.

The conversion processing unit CVU outputs the position information associated with the URL acquired by the image marker identification processing unit MRU based on the correspondence table TBL. The position information output by the conversion processing unit CVU is transmitted to the self-position estimation processing unit LCU.

2-4. Position Information Acquisition Method

Hereinafter, the position information acquisition method executed by the position information acquisition system 20 according to the second embodiment will be described.

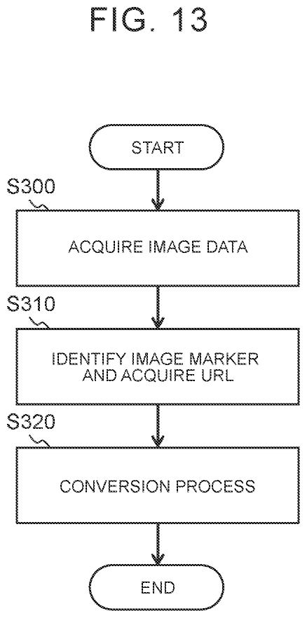

FIG. 13 is a flowchart showing a position information acquisition method executed by the position information acquisition system 20 according to the second embodiment. The process shown in FIG. 13 is executed when the vehicle 1 is stopped at the specific location SP and the camera CAM is capturing an image of the image marker MK. The determination of the start of the process may be repeated at predetermined intervals, or may be made on condition that the operator of the vehicle 1 or the like performs a predetermined operation of the HMI device 300.

In step S300, the camera CAM captures an image of the environment around the vehicle 1, and the information processing device 100 acquires the image data from the camera CAM. After step S300, the process proceeds to step S310.

In step S310, the image marker identification processing unit MRU identifies the image marker MK from the image data and acquires the URL. After step S310, the process proceeds to step S320.

In step S320, the conversion processing unit CVU acquires the position information associated with the acquired URL based on the correspondence table TBL. After step S320, the process ends.

2-5. Effect

As described above, with the position information acquisition system 20 according to the second embodiment, the vehicle 1 can acquire the position information at the specific location SP using the image marker MK installed at the specific location SP. In addition, the code represented by the image marker MK can be configured to indicate appropriate data. Particularly, assuming that the code represented by the image marker MK indicates a URL, the web page specified by the URL can be information meaningful to the user USR (for example, timetable or service information). As a result, it is possible to prevent the user USR from acquiring meaningless information from the image marker MK.

2-6. Modification

The position information acquisition system 20 according to the second embodiment may adopt a modified mode as follows. Hereinafter, matters described in the above-described contents are omitted as appropriate.

2-6-1. First Modification

The conversion processing unit CVU may be configured to execute a process of extracting a specific part from the URL acquired by the image marker identification processing unit MRU and output the position information associated with the extracted part. In this case, the correspondence table TBL serves as data that associates the position information with the extracted part.

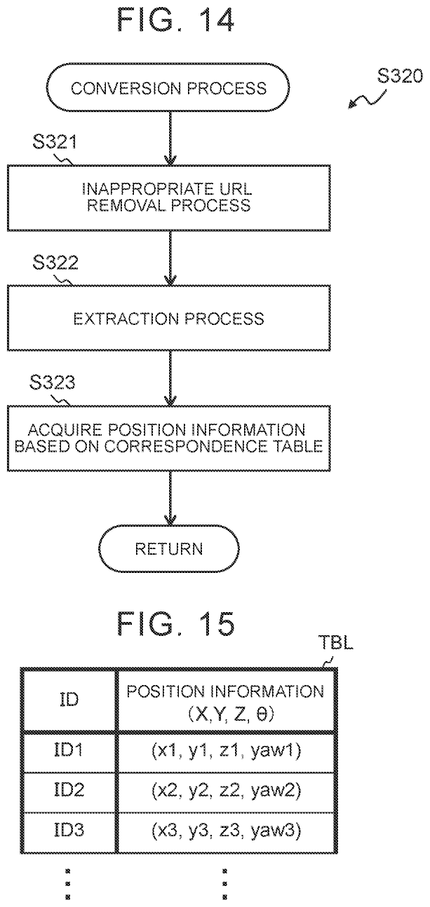

FIG. 14 is a flowchart showing a process executed by the conversion processing unit CVU (step S320 in FIG. 13) in the position information acquisition system 20 according to a first modification of the second embodiment. Here, assuming that the format of the URL acquired from each image marker MK is http://XXX.IDj (j=1, 2, . . . ) as shown in FIG. 11A, IDj is defined as a specific part.

In step S321, the conversion processing unit CVU removes an inappropriate URL that is not the target. For example, when the acquired URL does not correspond to the format of http://XXX.IDj, it is determined that the position information is not acquired. This makes it possible to prevent erroneous determination by reading the code indicating only the specific part. After step S321, the process proceeds to step S322.

In step S322, the conversion processing unit CVU extracts the specific part. For example, when the acquired URL is http://XXX.IDj, the part of IDj is extracted. After step S322, the process proceeds to step S323.

In step S323, the conversion processing unit CVU acquires the position information associated with the extracted specific part based on the correspondence table TBL. FIG. 15 is a conceptual diagram showing an example of the correspondence table TBL according to the first modification of the second embodiment. As shown in FIG. 15, the correspondence table TBL is data for associating the position information with the extracted specific part (ID). After step S323, the process ends.

By adopting the modified mode as in the first modification, the size of the data of the correspondence table TBL can be reduced.

2-6-2. Second Modification

The image marker identification processing unit MRU may be configured to further acquire information on the category of the code represented by the image marker MK. The conversion processing unit CVU may be configured to output the position information associated with the combination of the URL and the category of the code acquired from the image marker MK.

The code represented by the image marker MK can generally be given a plurality of categories that is not related to the data. For example, in a matrix-type two-dimensional code, the direction of the code is given by a finder pattern. The category of the code can be given depending on the direction of the code. Alternatively, the category of the code can be given depending on the code version, the code mask pattern, the difference in code size, the error correction level, and the like.

The image marker identification processing unit MRU according to the second modification further acquires information on such a category of the code represented by the image marker MK, and transmits the acquired information on the category of the code to the conversion processing unit CVU. Based on the correspondence table TBL, the conversion processing unit CVU outputs the position information associated with the combination of the URL and the category of the code acquired from the image marker MK. In this case, the correspondence table TBL serves as data that associates the combination of the URL and the category of the code with the position information.

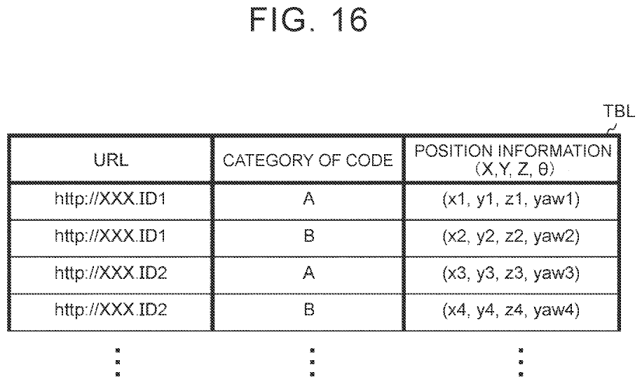

FIG. 16 is a conceptual diagram showing an example of the correspondence table TBL according to the second modification of the second embodiment. As shown in FIG. 16, the correspondence table TBL is data that associates the position information with a combination of the URL and the category of the code. That is, even when the URL is the same, when the category of the code is different, different position information is associated. It should be noted that the correspondence table TBL may be data that associates the position information with a combination of the URL and a plurality of categories of the code.

By adopting the modified mode as in the second modification, a larger number of types of position information can be associated with one URL.

2-6-3. Third Modification

The information processing device 100 may be configured to execute a process of specifying an area for identifying the image marker MK (identification area IDA) from the image data acquired from the camera CAM.

By adopting the modified mode as in a third modification and calculating the identification area IDA, it is possible to reduce erroneous recognition and improve the reading speed in the identification of the image marker MK performed by the information processing device 100. In addition, the size and the flexibility of the installation location of the image marker MK can be improved.

What is claimed is:

1. A position information acquisition system that acquires position information that allows a vehicle to specify a position and a posture of the vehicle itself on a map, the position information acquisition system comprising:
a server that receives request data from a terminal and transmits information corresponding to a content of the request data to the terminal;
a plurality of image markers each representing a code that allows acquisition of the request data by a predetermined identification method;
a camera that is provided in the vehicle and that captures an environment around the vehicle;
an information processing device that is provided in the vehicle and that executes a process of identifying the image marker imaged by the camera based on the identification method and acquiring the request data; and
a communication device that is provided in the vehicle, that transmits the request data to the server, and that receives information from the server, wherein:
each of the image markers is installed at a specific location; and
when the server receives the request data from the vehicle, the server transmits the position information at the specific location where the image marker is installed to the vehicle regardless of the content of the request data.

2. The position information acquisition system according to claim 1, wherein the server is a web server and the request data is a URL.

3. A position information acquisition system that acquires position information that allows a vehicle to specify a position and a posture of the vehicle itself on a map, the position information acquisition system comprising:
a plurality of image markers each representing a code that allows acquisition of data by a predetermined identification method;
a camera that is provided in the vehicle and that captures an environment around the vehicle; and
an information processing device provided in the vehicle, wherein:
each of the image markers is installed at a specific location; and
the information processing device
stores a correspondence table for associating the position information at the specific location with the data, and
executes
a process of acquiring information from the camera,
an identification process of identifying the image marker imaged by the camera based on the identification method and acquiring the data, and
a conversion process of acquiring the position information associated with the data acquired by the identification process based on the correspondence table.

4. The position information acquisition system according to claim 3, wherein the data is a URL.

5. The position information acquisition system according to claim 3, wherein:
the correspondence table associates the position information at the specific location with a combination of the data and a category of the code;
in the identification process, the information processing device further acquires information on the category of the code represented by the image marker imaged by the camera; and
in the conversion process, the information processing device acquires the position information associated with the combination of the data acquired by the identification process and the category of the code based on the correspondence table.

6. A position information acquisition method for acquiring position information that allows a vehicle to specify a position and a posture of the vehicle itself on a map, wherein:
a server is a device that receives request data from a terminal and transmits information corresponding to a content of the request data to the terminal;
an image marker is a marker that is installed at a specific location and that represents a code that allows acquisition of the request data by a predetermined identification method;
in the vehicle, a processor that executes at least one program executes
a process of acquiring information from a camera that images an environment around the vehicle,
a process of identifying the image marker imaged by the camera based on the identification method and acquiring the request data, and
a process of transmitting the request data to the server and receiving information from the server; and
in the server, a processor that executes at least one program executes
a process of determining whether a transmission source of the received request data is the vehicle, and
a process of transmitting, when the transmission source of the received request data is the vehicle, the position information at the specific location where the image marker is installed to the vehicle regardless of the content of the request data.

7. A position information acquisition method for acquiring position information that allows a vehicle to specify a position and a posture of the vehicle itself on a map, wherein:
an image marker is a marker that is installed at a specific location and that represents a code that allows acquisition of data by a predetermined identification method; and
a processor that executes at least one program executes
a process of acquiring information from a camera that images an environment around the vehicle,
an identification process of identifying the image marker imaged by the camera based on the identification method and acquiring the data, and
a process of acquiring the position information associated with the data acquired by the identification process based on a correspondence table that associates the position information at the specific location with the data.
